(19) United States
(12) Patent Application Publication
(10) Pub. No.: US 2019/0068475 A1
(43) Pub. Date: Feb. 28, 2019

(54) SYSTEM AND METHOD FOR THE UTILIZATION OF MESH NETWORKS AND DISTRIBUTED DATA BUFFERING TO INCREASE DATA RETENTION

(71) Applicant: Bsquare Corp., Bellevue, WA (US)

(72) Inventors: David Wagstaff, Lake Forest, CA (US); Matthew Honaker, Seattle, WA (US)

(21) Appl. No.: 16/112,814

(22) Filed: Aug. 27, 2018

Related U.S. Application Data
(60) Provisional application No. 62/550,881, filed on Aug. 28, 2017.

(51) Int. Cl. H04L 12/26; G06F 12/06

(52) U.S. Cl. CPC H04L 43/0894; G06F 12/0607; H04W 84/18; G06F 2212/1044; H04L 43/16

(57) ABSTRACT

An outbound data route for data is selected for data. The intake of data is monitored along with a data rate for the data. Further data context is generated to influence the selection of the outbound data route by a rule engine, which also utilizes the data rate and the connectivity of each of the outbound data routes to efficiently determine the outbound data route to select.

This application claims the benefit of U.S. provisional patent application Ser. No. 62/550,881, filed on Aug. 28, 2017, the contents of which are incorporated herein by reference in their entirety.

### BACKGROUND

Internet connected systems and devices that stream data may present problems in areas or conditions with less than perfect connectivity. A device may only have access to a connection with a constrained data limit or may have situations where the connection may be interrupted entirely for long periods of time. This creates the issue of data loss, which may severely impact applications where data consistency is paramount. Many Internet of Things (IOT) devices built for streaming have limited capabilities when it comes to dealing with network connectivity problems beyond limited buffering. Furthermore, buffering is generally limited to each individual device and data saved to the buffer continuously may use up all of the available space, saving a large amount of data points but a large gap in data at the end of a prolonged disconnection.

### BRIEF SUMMARY

The present system increases the efficiency of data distribution systems by determining available data flow resources and utilizing rules and algorithms to determine the resources to be utilized by the data flow. The algorithms may utilize factors such as traffic (data flow) and the speed of a given rule or orchestration. The system may also plan for data that will take a long time to process on certain algorithms. That is the system may process “slow” data through one algorithm, while some other data may be processed a in a different way, increasing the overall efficiency of the system. Finally, the system may utilize distributed buffers to stored data until a connection is available. The distributed buffers may utilize algorithms to efficiently store the data.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a system for the utilization of mesh networks and distributed data buffering to increase data retention 100.

FIG. 2 illustrates an embodiment of a method for the utilization of mesh networks and distributed data buffering to increase data retention 200.

FIG. 3 illustrates an embodiment of a system for the utilization of mesh networks and distributed data buffering to increase data retention 300.

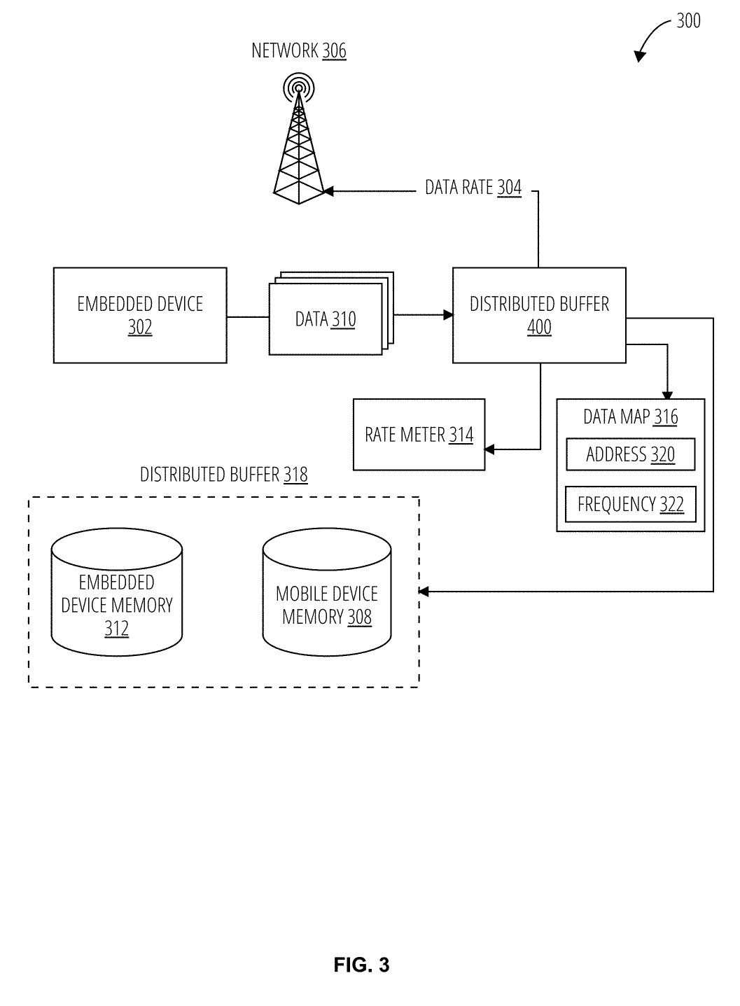

FIG. 4 illustrates an embodiment of a distributed buffer 400.

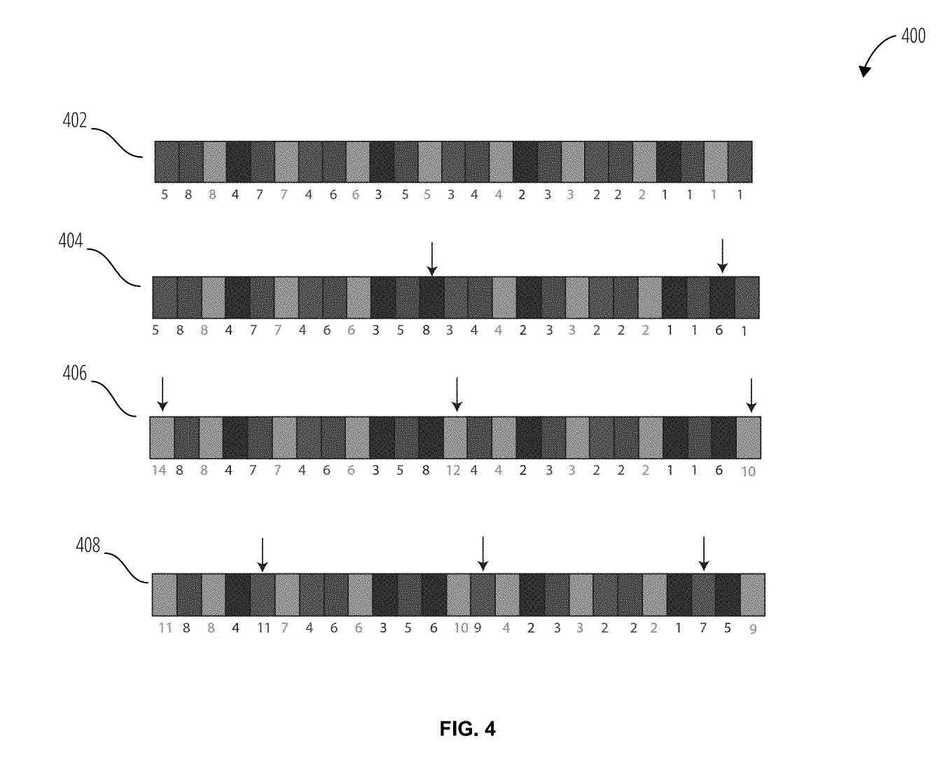

FIG. 5 illustrates a system 500 in accordance with one embodiment.

### DETAILED DESCRIPTION

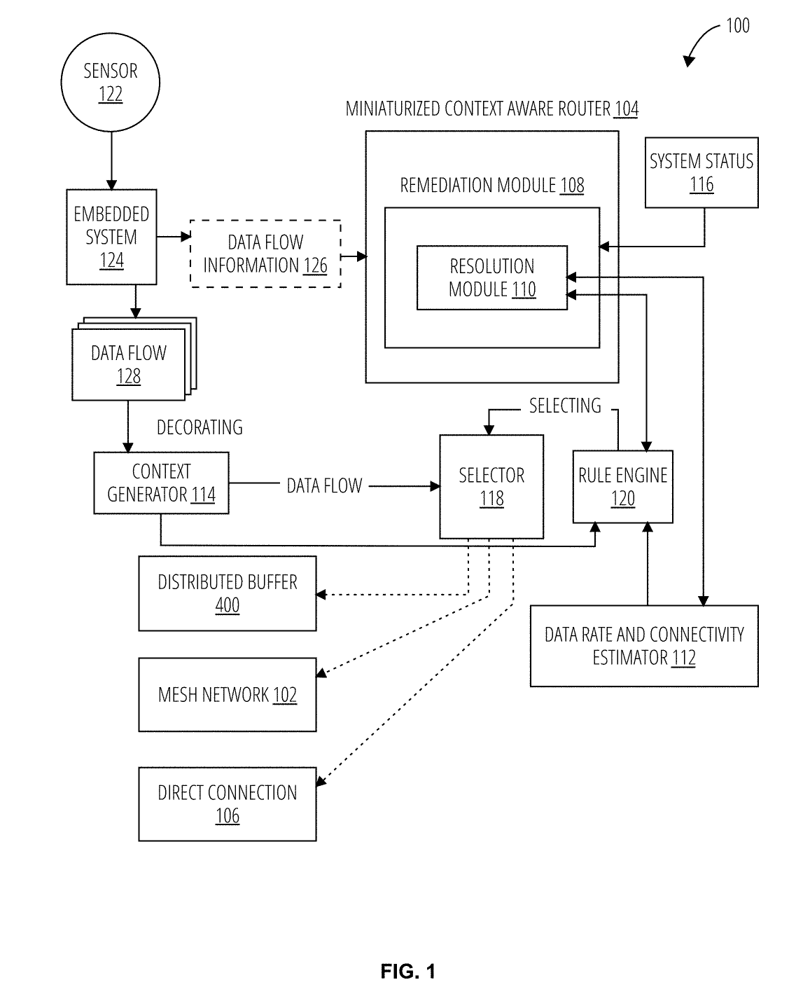

Referring to FIG. 1, the system for the utilization of mesh networks and distributed data buffering to increase data retention 100 comprises a distributed buffer 400, a mesh network 102, a miniaturized context aware router 104, a direct connection 106, a data rate and connectivity estimator 112, a context generator 114, a system status 116, a selector 118, a sensor 122, an embedded system 124 and a rule engine 120. The miniaturized context aware router 104 further comprises a remediation module 108, and a resolution module 110.

The system for the utilization of mesh networks and distributed data buffering to increase data retention 100 executes on rules that may operate very quickly and determines which algorithms or outbound data routes (e.g., distributed buffer 400, mesh network 102) to shunt data to, based on a variety of factors such as traffic (data flow) and the speed of a given rule or orchestration. The remediation module 108 may also plan for data that will take a long time to process on certain algorithms. The resolution module 110 may know it will have to process the “slow” data through one algorithm, while some other data (e.g., the “fast” data) may be processed in a different way. The determination of whether data is categorized as “slow” or “fast” may be based on a threshold value. This threshold value may be pre-determined or may be dynamically determined. A dynamically determined threshold value may be based on the data rate. The categorization of the data to be processed may be based on the “O” complexity, a machine learned complexity, or by some other method. Based on these complexities, the data may be categorized into hierarchies of prioritization. One skilled in the art would understand how to implement the component to have these features according to the particular implementation they are building, without undo experimentation.

The miniaturized context aware router 104 may be employed on an embedded system or other “edge” device and receives the data flow information 126 from sensors or another device. The data rate and connectivity estimator 112 estimates the data rate and connectivity of the available data connections. The context generator 114 monitors the priority level and other context surrounding the data. The context generator 114 may receive and store priorities (e.g., as a look-up table) and other context for each data flow 128. The context generator 114 then receives the data flow 128 and associates the data flow 128 with a priority and other context. The context generator 114 generates a context signal with the priority and other context and sends the context signal to the rule engine 120, the context signal providing priorities associated with data packets within the data flow. One skilled in the art would understand how to implement the component to have these features according to the particular implementation they are building, without undo experimentation.

The data rate and connectivity estimator 112 estimates the data flow rate and connectivity for the distributed buffer 400, the mesh network 102, and the direct connection 106 and sends an outflow estimation signal to the rule engine 120. The rule engine 120 applies data rules to route data based on data priority and cost and pairing it with an appropriate data route. The rule engine 120 may store or receive a cost associated with various data flows. In some embodiments, the rule engine 120 may store tables that cross-references priority and cost and return an appropriate data route. Multiple tables may be utilized based on available data paths and other data flows. The data rules may be adapted to specific system to which the system for the utilization of mesh networks and distributed data buffering to increase data retention 100 applies and received by the system for the utilization of mesh networks and distributed data buffering to increase data retention 100. Further data rules may be received during operation. One skilled in the art would understand how to implement the component to have these features according to the particular implementation they are building, without undo experimentation.

If the data rate and connectivity estimator 112 estimates that there will be a poor connection or the system experiences a loss of connectivity, the system may buffer data utilizing a distributed buffer 400.

The data rate and connectivity estimator 112 communicates data flow information to the remediation module 108. The data rate and connectivity estimator 112 communicates the estimated speed to process data flow the network direct connection 106, the mesh network 102 and the distributed buffer 400. The rule engine 120 orders data flow in accordance with processing speed. The resolution module 110 communicates a selecting signal to the resolution module 110 to select the distributed buffer 400 or the mesh network 102 to receive the data flow. The selector 118 receives a data flow from systems sensors or another system via the context generator 114.

The system may utilize rules from the rule engine 120 to determine the priority of data associated with specific contexts. For example, the rule engine 120 may indicate that information coming from “unhealthy” subsystems receive higher priority than those from “healthy” subsystems. The “healthiness” of a subsystem may be determined by that subsystem, which may indicate the “healthiness” of the subsystem, or the “healthiness” of a subsystem may be determined by an external system, the system for the utilization of mesh networks and distributed data buffering to increase data retention 100 receiving a “healthiness” indication from the external system. For example, the data from a subsystem may indicate that the subsystem may be close to failing. That subsystem then be determined to be “unhealthy”. The system for the utilization of mesh networks and distributed data buffering to increase data retention 100 may then utilize the “unhealthy” label to set a priority for the data from that subsystem.

The data rate and connectivity estimator 112 may determine that connectivity to the network via a direct connection 106 has been reduced to zero; however, there may be a connection to the network by routing the signal via another device via a local mesh network 102 at a lower data rate. The rule engine 120 may employ the mesh network 102 to route the data and may utilize the distributed buffer 400 as well to save data which may not be able to be transmitted at the lower rate. The system may also utilize the distributed buffer 400 and map data to storage on the system or on different systems it is connected to.

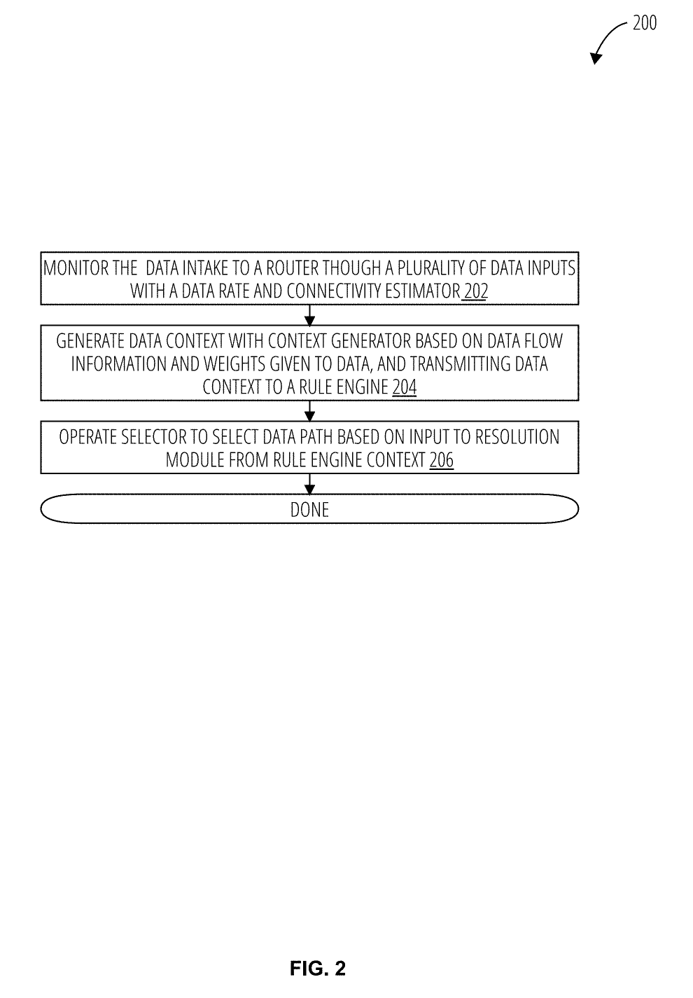

The system for the utilization of mesh networks and distributed data buffering to increase data retention 100 may be operated in accordance with the process described in FIG. 2.

Referencing FIG. 2, the method for the utilization of mesh networks and distributed data buffering to increase data retention 200 monitors the intake of data to a router on plurality of data inputs with a data rate and connectivity estimator (block 202). The method for the utilization of mesh networks and distributed data buffering to increase data retention 200 generates data context with a context generator based on data flow information and weights (e.g., the priority) given to the data and transmits the data context to a rule engine (block 204). The method for the utilization of mesh networks and distributed data buffering to increase data retention 200 operates a selector to select a data path based on input to a resolution module from the rule engine regarding the data's data rate and network connectivity of the plurality of data inputs (block 206).

The system for the utilization of mesh networks and distributed data buffering to increase data retention 300 comprises a distributed buffer 400, an embedded device 302, a data rate 304, a network 306, a mobile device memory 308, a data 310, an embedded device memory 312, a rate meter 314, a data map 316, a distributed buffer 318, an address 320, and a frequency 322.

The embedded device 302 transmits the data 310 to the distributed buffer 400. The distributed buffer 400 may be located in one device or across different devices (i.e., the host device(s)) based on the connectivity between devices and the availability of storage. The data map 316 may map the data 310 to the distributed buffer 318, recording the address 320 and the frequency 322 (or patterns) of data storage. The rate meter 314 monitors the data rate 304 and the distributed buffer 318 and adjusts the sample frequency of recorded data. The rate meter 314 may also trigger a data overwrite of previously recoded data by interleaving the new data.

The system for the utilization of mesh networks and distributed data buffering to increase data retention 300 may be operated in accordance with the process outlined in FIG. 2.

The distributed buffer 400 comprises recorded data 402, recorded data 404, recorded data 406, and recorded data 408. The recorded data may be blue, green, purple, or red, which are prioritized in that order. The data may be throttled such that every other data point is captured to be stored. Lower priority data points are overwritten by those with a priority one step higher. Thus, data from one step of higher priority replaces data from one step lower in priority. The distributed buffer 400 may writes in either direction and the frequency of the samples may be specified. Additionally, the oldest data point may be retained when determining which data to overwrite and the next oldest may be overwritten. Furthermore, the distributed buffer 400 may overwrite the same sample data with a newer sample.

The distributed buffer 400 may record the recorded data 402 based on the data rate 304 and the availability of storage. The recorded data 402 is the initial buffer, which comprises four (4) blue data points, eight (8) green data points, five (5) purple data points, and eight (8) red data points.

The recorded data 404 represents the distributed buffer 400 after a blue data point data overwrite to the recorded data 402. As green data points are one step lower in priority, green data points are overwritten by the new blue data points. As depicted, blue data point “6” overwrites green data point “1”, and blue data point “8” overwrites green data point “5”. There are now six (6) blue data points, six (6) green data points, five (5) purple data points, and eight (8) red data points.

The recorded data 406 represents the distributed buffer 400 after a green data point data overwrite to the recorded data 404. As purple data points are one step lower in priority, purple data points are overwritten by the new green data points. As depicted, green data point “10” overwrites purple data point “1”, green data point “12” overwrites purple data point “3”, and green data point “14” overwrites purple data point “5”. There are now six (6) blue data points, nine (9) green data points, two (2) purple data points, and eight (8) red data points.

The recorded data 408 represents the distributed buffer 400 after a purple data point data overwrite to the recorded data 406. As red data points are one step lower in priority, red data points are overwritten by the new purple data points. As depicted, purple data point “7” overwrites red data point “1”, purple data point “9” overwrites red data point “4”, and purple data point “11” overwrites red data point “7”. There are now six (6) blue data points, nine (9) green data points, five (5) purple data points, and five (5) red data points.

The distributed buffer 400 thus may dynamically increase compression of the recorded data by interleaving data blocks of new data into currently recorded data, decreasing the number of recorded samples, and the resolution of the recorded data, but maintaining the consistency of the data sample set as a whole.

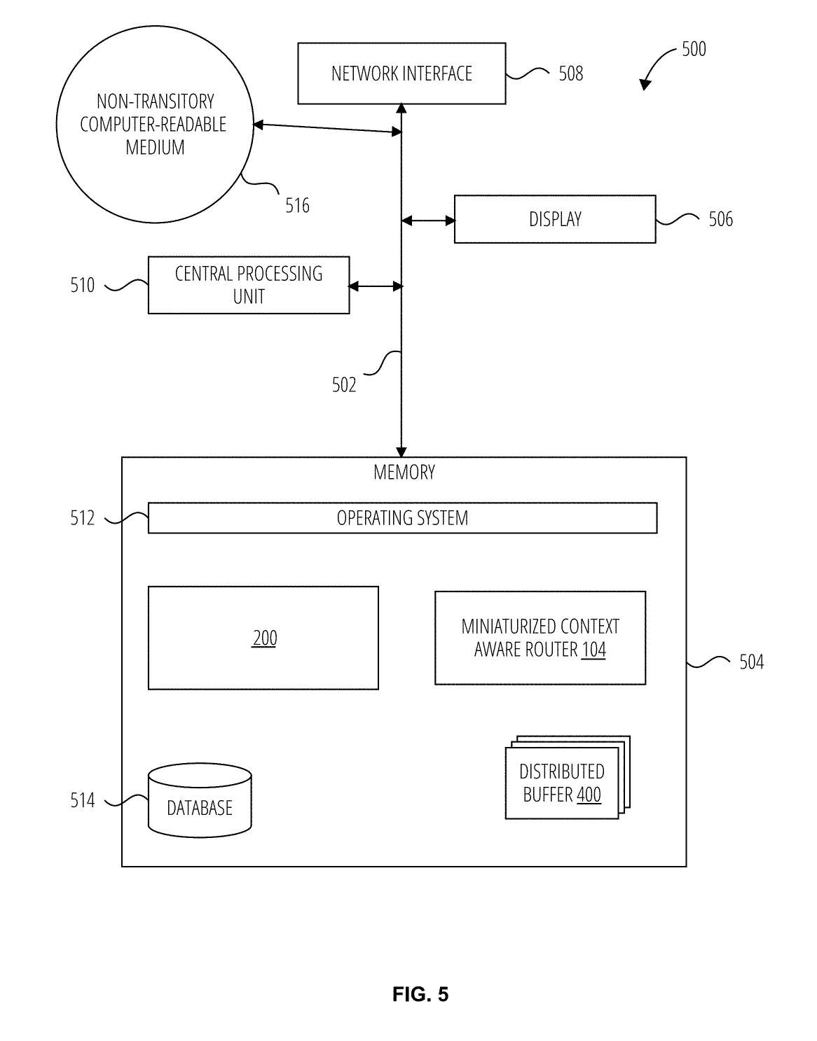

FIG. 5 illustrates several components of an exemplary system 500 in accordance with one embodiment. In various embodiments, system 500 may include a desktop PC, server, workstation, mobile phone, laptop, tablet, set-top box, appliance, or other computing device that is capable of performing operations such as those described herein. In some embodiments, system 500 may include many more components than those shown in FIG. 5. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 500 may comprise one or more physical and/or logical devices that collectively provide the functionalities described herein. In some embodiments, system 500 may comprise one or more replicated and/or distributed physical or logical devices.

In some embodiments, system 500 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 500 includes a bus 502 interconnecting several components including a network interface 508, a display 506, a central processing unit 510, and a memory 504.

Memory 504 generally comprises a random access memory (“RAM”) and permanent non-transitory mass storage device, such as a hard disk drive or solid-state drive. Memory 504 stores an operating system 512.

These and other software components may be loaded into memory 504 of system 500 using a drive mechanism (not shown) associated with a non-transitory computer-readable medium 516, such as a DVD/CD-ROM drive, memory card, network download, or the like.

Memory 504 also includes database 514. In some embodiments, system 500 may communicate with database 514 via network interface 508, a storage area network (“SAN”), a high-speed serial bus, and/or via the other suitable communication technology.

In some embodiments, database 514 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Programmable device” in this context refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Software” in this context refers to logic implemented as processor-executable instructions in a machine memory (e.g. read/write volatile or nonvolatile memory or media).

“connectivity” in this context refers to the quality, state, or capability of being connective or connected.

“data” in this context refers to the quantities, characters, or symbols on which operations are performed by a computer, being stored and transmitted in the form of electrical signals and recorded on magnetic, optical, or mechanical recording media.

“data rate” in this context refers to the speed with which data can be transmitted from one device to another.

“mesh network” in this context refers to a local network topology in which the infrastructure nodes (i.e. bridges, switches and other infrastructure devices) connect directly, dynamically and non-hierarchically to as many other nodes as possible and cooperate with one another to efficiently route data from/to clients.

“data rate and connectivity estimator” in this context refers to a packet analyzer (also known as a packet sniffer), which is a computer program or piece of computer hardware that can intercept and log traffic that passes over a digital network or part of a network. Packet capture is the process of intercepting and logging traffic. As data streams flow across the network, the sniffer captures each packet and, if needed, decodes the packet's raw data, showing the values of various fields in the packet, and analyzes its content according to the appropriate RFC or other specifications. A packet analyzer used for intercepting traffic on wireless networks is known as a wireless analyzer or WiFi analyzer. A packet analyzer can also be referred to as a network analyzer or protocol analyzer though these terms also have other meanings. Exemplary commercial packet analyzers include Capsa® Network Analyzer, CommView®, Microsoft® Network Monitor, etc.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

Those having skill in the art will appreciate that there are various logic implementations by which processes and/or systems described herein can be effected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

The foregoing detailed description has set forth various embodiments of the devices or processes via the use of block diagrams, flowcharts, or examples. Insofar as such block diagrams, flowcharts, or examples contain one or more functions or operations, it will be understood as notorious by those within the art that each function or operation within such block diagrams, flowcharts, or examples can be implemented, individually or collectively, by a wide range of hardware, software, firmware, or virtually any combination thereof. Portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more processing devices (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

What is claimed is:

1. A method comprising:
monitoring intake of data to a router through a plurality of data inputs with a data rate and connectivity estimator and generating a data rate;
generating data context with a context generator based on data flow information and weights given to the data, and transmitting the data context to a rule engine; and
operating a selector with a selection signal from the rule engine to select a particular outbound data route from the router based on input regarding the data context, the data rate, and connectivity of each of a plurality of outbound data routes, the particular outbound data route being selected from a distributed data buffer, a mesh network, and a direct network connection, the distributed data buffer's memory locations distributed across multiple devices and selected based on the memory locations host device's connectivity and write speed.

2. The method of claim 1, further comprising categorizing the data as fast data or as slow data based on a threshold value, the particular outbound data route selection influenced by whether the data is the fast data or the slow data.

3. The method of claim 2, wherein the threshold value is dynamically determined based on the data rate.

4. The method of claim 1, wherein the particular outbound data route is further selected based on a priority level of the data and a cost to send the data.

5. The method of claim 4, wherein the priority level is based on a subsystem from which the data is received.

6. The method of claim 1, wherein a data map records the memory locations on the distributed data buffer, the data map further comprising a collection of memory addresses and patterns.

7. The method of claim 1, wherein a rate meter triggers an overwrite of the data which was previously recorded in the distributed data buffer by interleaving new data.

8. The method of claim 7, wherein the rate meter further adjusts a sample frequency for the overwrite of the data recorded based on the data rate and the data recorded in the distributed data buffer.

9. A computing apparatus, the computing apparatus comprising:
a processor; and
a memory storing instructions that, when executed by the processor, configure the apparatus to:
monitor intake of data to a router through a plurality of data inputs with a data rate and connectivity estimator and generating a data rate;
generate data context with a context generator based on data flow information and weights given to the data, and transmitting the data context to a rule engine; and
operate a selector with a selection signal from a resolution module to select a particular outbound data route from the router based on input from the rule engine regarding the data context, the data rate, and connectivity of each of a plurality of outbound data routes, the particular outbound data route being selected from a distributed data buffer, a mesh network, and a direct network connection, the distributed data buffer's memory locations distributed across multiple devices selected based on the memory locations host device's connectivity and write speed.

10. The computing apparatus of claim 9, wherein the instructions further configure the apparatus to categorize the data as fast data or as slow data based on a threshold value, the particular outbound data route selected influenced by whether the data is the fast data or the slow data.

11. The computing apparatus of claim 10, wherein the threshold value is dynamically determined based on the data rate.

12. The computing apparatus of claim 9, wherein the particular outbound data route is further selected based on a priority level of the data and a cost to send the data.

13. The computing apparatus of claim 12, wherein the priority level is based on a subsystem from which the data is received.

14. The computing apparatus of claim 9, wherein a data map records the memory locations on the distributed data buffer, the data map wherein the instructions further configure the apparatus to a collection of memory addresses and patterns.

15. The computing apparatus of claim 9, wherein a rate meter triggers an overwrite of the data which was previously recorded in the distributed data buffer by interleaving new data.

16. The computing apparatus of claim 15, wherein the rate meter further adjusts a sample frequency for the overwrite of the data recorded based on the data rate and the data recorded in the distributed data buffer.
